(19) United States
(12) Patent Application Publication
(10) Pub. No.: US 2004/0083904 A1
(43) Pub. Date: May 6, 2004

(54) Inner pot of the roasting oven with steaming boxes

(76) Inventor: Jian Wei-Wen, Guangdong (CN)

Correspondence Address: DICKINSON WRIGHT PLLC, Suite 800, 1901 L Street, N.W., Washington, DC, 20036, US

(21) Appl. No.: 10/370,743

(22) Filed: Feb. 24, 2003

(30) Foreign Application Priority Data
Oct. 30, 2002 (CN) 02248969.X

(51) Int. Cl. A47J 9/00

(52) U.S. Cl. 99/448; 99/483

(57) ABSTRACT

An inner pot of the roasting oven with steaming boxes comprising an inner pot (1) and at least two steaming boxes (2) is characterized in that the hat-tab like lid rims (6) extending laterally are provided on the peripheries of the upper openings of the steaming boxes (2), and the steaming boxes (2) are arranged side by side on the upper opening of the inner pot which are then laid on the edge of the upper opening of the inner pot through the lid rims (6) of their upper openings. The pallet provided in the inner pot of the traditional roasting oven with steaming boxes is eliminated which causes not only savings in material, decreasing cost, convenience in use, but also minimizes the volume and the cost of packaging and handling.

### TECHNICAL FIELD

The utility model is related to an inner pot of a roasting oven comprising steaming boxes.

### BACKGROUND ART

In order to multiply functions there is a need to provide the inner pot of a roasting oven with steaming boxes for putting roasting food. When there is a need to steam food or to keep the food warm, water is usually poured into an inner pot and the steaming boxes containing food inside are put on the upper part of the inner pot, thereby heating the food. As shown in FIG. 1, in the existing electric roasting ovens or other roasting ovens a special pallet with openings (3) having its periphery laid on the upper rim of the inner pot (1) is provided for the steaming boxes (2) to be put on the upper part of the inner pot (1). The steaming boxes (2) are inserted into the openings (4) of the pallet (3) which is then put on the upper part of the inner pot (1). This structure increases the cost of the packaging during handling because of the diameter of the pallet (3) being greater than that of the inner wall of the inner pot (1) which prevents the pallet (3) from being put inside the inner pot (1).

### DISCLOSURE OF THE UTILITY MODEL

The objective of the utility model is to provide an inner pot of the roasting oven with steaming boxes which is able to minimize the consumption of materials, and the cost of the product and reduce the cost of packaging as well as handling.

The layout of the utility model is as follows (refer to FIGS. 2-5). An inner pot of the roasting oven with steaming boxes comprising an inner pot (1) and at least 2 steaming boxes (2) is characterized in that their rim lids (6) are shaped like the rim of a hat, i.e., a hat rim (6) that extends laterally. The rim lids (6) are provided or located on the peripheries of the upper openings of the steam boxes (2), and the steaming boxes (2) are arranged side by side on the upper opening of the inner pot (1). When the steaming boxes (2) are placed in the inner pot (1), the lid rims (6) located on the upper openings of the steam boxes (6) are then laid on the edge of the upper opening of the inner pot (1). Thus, the pallet (3) provided in the inner pot (1) of the traditional roasting oven with steaming boxes is eliminated which causes not only savings in material, decreasing cost, and convenience in use, but also minimizes the volume of the package and minimizes the cost of packaging and handling.

### BRIEF DESCRIPTION OF THE DRAWINGS

The present invention will become more fully understood from the detailed description given here below, the appended claims, and the accompanying drawings in which:

FIG. 1 is the schematic view of the structure of the existing inner pot of the roasting oven with steaming boxes;

FIG. 2 is the schematic view of the structure of the inner pot 1 with the steaming boxes 2 put inside through the pallet 3;

FIG. 3 is the schematic view of the structure of the utility model;

FIG. 4 is the schematic view of the structure of the embodiment shown in FIG. 2 with the steaming boxes 2 laid on the upper opening of the inner pot 1;

FIG. 5 is the schematic view of the structure of an electric roasting oven assembled from the embodiment;

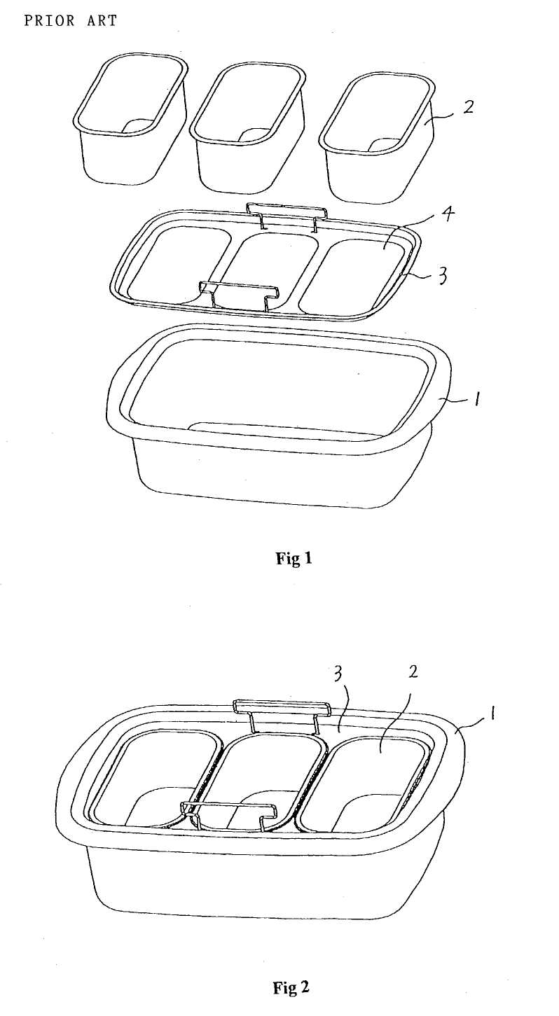

### THE PREFERRED EMBODIMENT

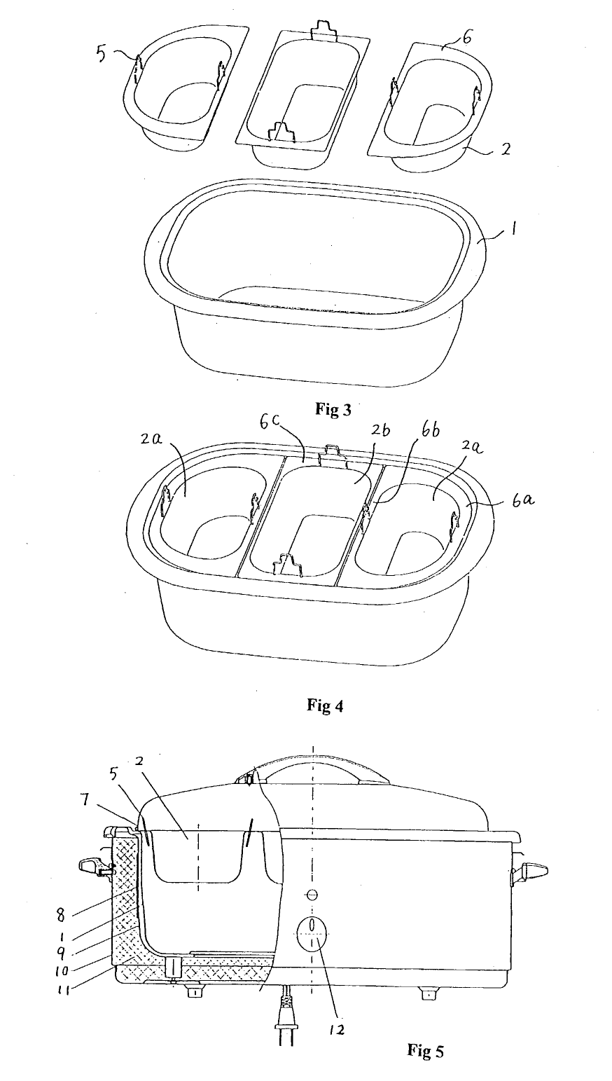

A preferred embodiment comprises an inner pot (1) of the electric roasting oven. The roasting oven comprises an inner pot (1), steaming boxes (2) with handles (5) and lid rims (6), a cover (7), an electrothermal element (8), an outer pot (9), a housing (10), heat preservation material (11), and a panel (12). The cross section of the inner pot (1) is circular in shape which is elongated in a longitudinal direction. It has two ends having an arcuate shape and two sides which have a straight shape (see FIGS. 2, 3 and 4). In it are three steaming boxes (2) arranged side by side. The outer part of the lid rims (6a) of the two outer steaming boxes (2a,c) have an arcuate shape (see FIGS. 3 and 4) and are laid on the arcuate edges of the upper opening of the inner pot (1). The inner parts of the lid rims (6b) are straight in shape and are located adjacent to the inner edges of the lid rim (6) of the intermediate steaming box (2b) which are also straight. The parts of the lid rims 6c located laterally at opposite sides of the intermediate steaming box (2b) are laid on the straight edges of the upper opening of the inner pot (1) (See FIG. 4). Thus, the upper opening of the inner pot (1) is covered by three steaming boxes (2) arranged in series. The three steaming boxes (2) also comprise handles (5).

The parts of the lid rims (6) between the adjacent steaming boxes (2) in the embodiment are located close to each other thus preventing the steam from excessive leakage from the inner pot (1) during the steaming process from condensing into water dropping on the food inside the steaming box.

FIG. 5 is the schematic view of the structure of the electric roasting oven assembled from the embodiment. The inner pot (1) is put inside the outer pot (9) which is then wound by an electrothermal element (8) from outside. The heat preservation material is provided between the outer pot (9) and the housing (10). The panel (12) is attached to the housing with a cover (7) provided on the inner pot.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A roasting oven with steaming boxes, comprising:
an inner pot having an upper opening;
at least two steaming boxes arranged side by side, wherein at least one of said steaming boxes comprises:
an upper opening;
a lid rim having an arcuate shaped outer part and a straight inner part, wherein said arcuate shaped outer part of said lid rim is located on a periphery of said upper opening of said steaming boxes; and
wherein said steaming boxes are laid on an edge of said upper opening of said inner pot.

2. The roasting oven with steaming boxes according to claim 1, wherein said lid rims located between adjacent of said steaming boxes are close to each other.

3. The roasting oven with steaming boxes according to claim 2, wherein said inner pot comprises an edge with two ends having an arcuate shape and two sides having a straight shape;
wherein said at least two steaming boxes comprise two outer steaming boxes and an intermediate steaming box arranged side by side; and
wherein said two outer steaming boxes comprise an arcuate shaped outer part of said lid rim laid on one of said arcuate ends of said edge of said upper opening of said inner pot; and
wherein said intermediate steaming box comprises a lid rim having two parts located on opposite sides of said intermediate steaming box laid on said two sides having a straight shape of said edge of said upper opening of said inner pot, whereby said upper opening of said inner pot is covered by said steaming boxes arranged in series.
